(19) United States
(12) Patent Application Publication
(10) Pub. No.: US 2011/0001932 A1
(43) Pub. Date: Jan. 6, 2011

(54) Navigation device

(76) Inventor: Sven Zuehlsdorff, Langenhagen (DE)

Correspondence Address: KENYON & KENYON LLP, ONE BROADWAY, NEW YORK, NY, 10004, US

(21) Appl. No.: 12/733,893

(22) PCT Filed: Sep. 15, 2008
(86) PCT No.: PCT/EP2008/062226

§ 371 Date: Jul. 19, 2010

(30) Foreign Application Priority Data
Nov. 9, 2007 (DE) 102007053422.3

(51) Int. Cl. G03B 21/00

(52) U.S. Cl. 353/14; 353/13

(57) ABSTRACT

A calculation device for use in a vehicle, having a housing and having a first planar display, disposed in the housing, for direct readout of information in the planar display, and having a second projection unit, disposed in the housing, for generating a virtual image, in particular on a windshield of the vehicle.

### BACKGROUND INFORMATION

U.S. Patent Application No. 2003/0160736 describes a portable display device for a vehicle, which device is disposed on an instrument panel of a vehicle. The display device has a liquid crystal display in which an image is displayed, and which is disposed so that the image is reflected in the windshield. The observer in the vehicle can thus see a virtual image as a result of the reflection in the windshield.

### SUMMARY OF THE INVENTION

The calculation device according to the present invention has the advantage that the calculation device has in one housing both a planar display and additionally a projection unit for generating a virtual image, in particular by way of light deflection on a windshield of a vehicle. It is thus on the one hand possible to make complex information available to the driver in the planar display, while particularly important information to be perceived quickly by the driver can be generated as a virtual image, in particular by reflection on the vehicle's windshield. The driver can use the planar display for operation of the calculation device and, for example, for the depiction of complex information, while he or she can also perceive important information via the windshield without having to look away from the vehicle's surroundings. Integration of the two display devices into the housing of the calculation device makes possible space-saving and economical implementation of both display variants.

It is advantageous to embody the projection unit with a plurality of light-emitting diodes that can at least in part be triggered separately, in order to allow various symbols to be depicted in the virtual image in simple fashion. Light-emitting diodes represent, in this context, a light source for projection that can be mounted easily and economically in the housing, and that furthermore can be installed in space-saving fashion.

It is further advantageous to dispose the projection unit on the narrow side of the housing, since in this fashion the display is visible from the front side for the observer, while the narrow side is directed onto a suitable reflective surface, for example the windshield.

It is furthermore also advantageous to configure the housing so it can be folded out, so that the projection unit is disposed on an inner side of the housing. If the calculation unit is embodied as a portable calculation unit, so that it can also be brought along by a user as a mobile device, the projection unit can correspondingly be protected by being folded together. It is further advantageous to provide an antenna unit, in particular an antenna unit of a satellite positioning system, in a part that can be folded out. At the same time, optimum reception of the satellite position signal can be enabled by a horizontal configuration of the folded-out flap having the projection unit.

It is further advantageous to configure the projection unit so that it can display multiple symbols. Advantageously, a separate light source assemblage is provided for each symbol, for independent triggering. Corresponding light-source surfaces for symbol formation can thus also be pre-shaped, so that only one of several symbols needs to be triggered in order to depict a symbol.

It is furthermore advantageous to provide a holder in order to attach the calculation device, advantageously, in such a way that the planar display is visible to an observer, while operation of the projection unit enables depiction of a virtual image. When the calculation device is removed from the holder, further operation of the projection unit is generally not useful, since a corresponding uniform orientation with respect to a reflective surface for generating the virtual image is not present. The projection unit is therefore advantageously automatically deactivated after a removal of the calculation device from the holder.

It is furthermore advantageous to embody the calculation device as a route determination unit for determining a route of travel to a destination and for outputting driving advisories, since corresponding devices are utilized particularly in vehicles, and with the calculation device according to the present invention, particularly good information to the vehicle driver regarding a route to be traveled increases driving safety. It is correspondingly advantageous to use a calculation device according to the present invention in a vehicle in order to generate a virtual image via the windshield of the vehicle, since in this case the mounting of further reflection apparatuses in the vehicle can be omitted, and the windshield is already sufficient for depiction of the virtual image.

### BRIEF DESCRIPTION OF THE DRAWINGS

FIG. 1 schematically depicts a calculation unit according to the present invention.

FIG. 2 is a first view, from the driver's position in the vehicle, of an installation example for installing in a vehicle a calculation unit according to the present invention in a first embodiment.

FIG. 3 is a further view, from outside the vehicle looking toward the driver's seat, of the calculation unit according to the present invention of FIG. 2.

FIG. 4 is a detail view, from the side, of the calculation unit according to the present invention in accordance with FIGS. 2 and 3.

FIG. 5 is a side view, looking toward the projection unit, of the calculation unit according to the present invention in accordance with FIGS. 2 to 4, removed from the vehicle.

FIGS. 6 through 8 show a further exemplifying embodiment of a calculation unit according to the present invention having a projection unit provided at a different point on the housing, with the housing in the folded-out state.

FIG. 9 shows the calculation device according to the present invention in accordance with FIGS. 6 to 8, in a folded-up state.

### DETAILED DESCRIPTION

The calculation device according to the present invention can be used in any vehicles. What is described below is the use of a calculation device according to the present invention for use in a motor vehicle.

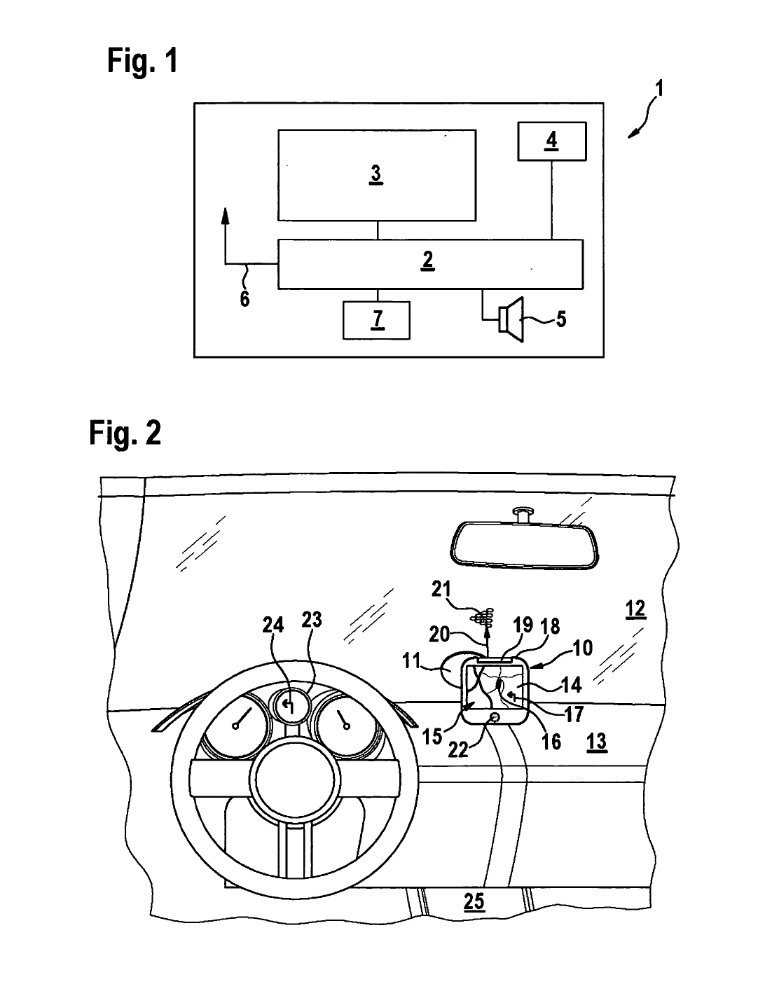

FIG. 1 schematically depicts a calculation device 1 according to the present invention. A control device 2, which triggers a planar display 3 and a projection unit 2, is disposed in a housing of calculation device 1. Calculation device 1 can be embodied as any computer, for example a portable one, which e.g. serves for appointment management, image reproduction, or sound reproduction. For acoustic output, a loudspeaker 5 is correspondingly connected to control device 2. In an embodiment, calculation device 1 is embodied as a navigation unit. For this purpose, calculation device 1 has a positioning unit 6 that is embodied, in particular, as a satellite positioning unit. Positioning unit 6 makes possible reception of a signal from satellites of a satellite positioning system. By way of a planar display 3 embodied, in particular, as a touch screen surface, a user can then enter a destination into calculation device 1. Control device 2 calculates a route of travel from the present position (ascertained via positioning unit 6) to the inputted destination, making use of a memory device 7 in which a corresponding road network is stored. When the driver needs to perform a driving maneuver along the calculated travel path, for example make a turn, a driving instruction is outputted via planar display 3, but in particular via projection unit 4. Acoustic driving instructions can correspondingly also be outputted via loudspeaker 5.

Planar display 3 is embodied, for example, as a liquid crystal display. A road map, for example, but also an input menu for inputting a destination, can be depicted in planar display 3. Driving instructions in particular, for example turn arrows, but optionally also warning symbols, can be outputted via projection unit 4. Projection unit 4 can also be constituted by any display. In an embodiment, projection unit 4 has a plurality of light-emitting diodes, which correspondingly have sufficient light intensity that the light emitted from projection unit 4 can reflect in the windshield of the vehicle in such a way that a virtual image is visible to an observer.

A first exemplifying embodiment of a use of a display apparatus according to the present invention in a motor vehicle is depicted in FIG. 2. A calculation device 10 according to the present invention is mounted on a holder (not visible in FIG. 2) that in turn is attached with a suction cup 11 on windshield 12 above an instrument panel 13 of the motor vehicle. A map depiction 15 is shown in planar display 14 of calculation device 10. In the embodiment shown here, position 16 of the motor vehicle is furthermore indicated in map depiction 15. The vehicle is now intended to turn to the left, as indicated e.g. by a left-turn arrow 17 in map depiction 15. In particular, however, display of a left-turn arrow is accomplished by way of a projection unit, disposed on the upper narrow side 18 of calculation device 10, that correspondingly emits a light beam 20 of light toward windshield 12. An arrow depiction 21 is correspondingly visible to an observer, as a result of reflection of the light on windshield 12, in the form of a virtual image. An acoustic advisory can be outputted in supplementary fashion via a loudspeaker 22 of calculation device 10. In a further embodiment, calculation device 10 can also possess a radio interface, such that a corresponding turn datum can be transferred to a display instrument 23 of the vehicle, so that a corresponding turn symbol 24 can also be depicted in display instrument 23 in front of the driver.

In the embodiment shown here, calculation device 10 is mounted above center console 25 of the vehicle on instrument panel 13. Because of the variable configuration using suction-cup attachment, however, the calculation device can also be positioned in a region above, or to the left alongside, display instrument 23. It is moreover also possible to position calculation device 10 in front of the passenger on windshield 12. In another embodiment (not shown in FIG. 2), it is alternatively also possible to attach calculation device 10 to instrument panel 13.

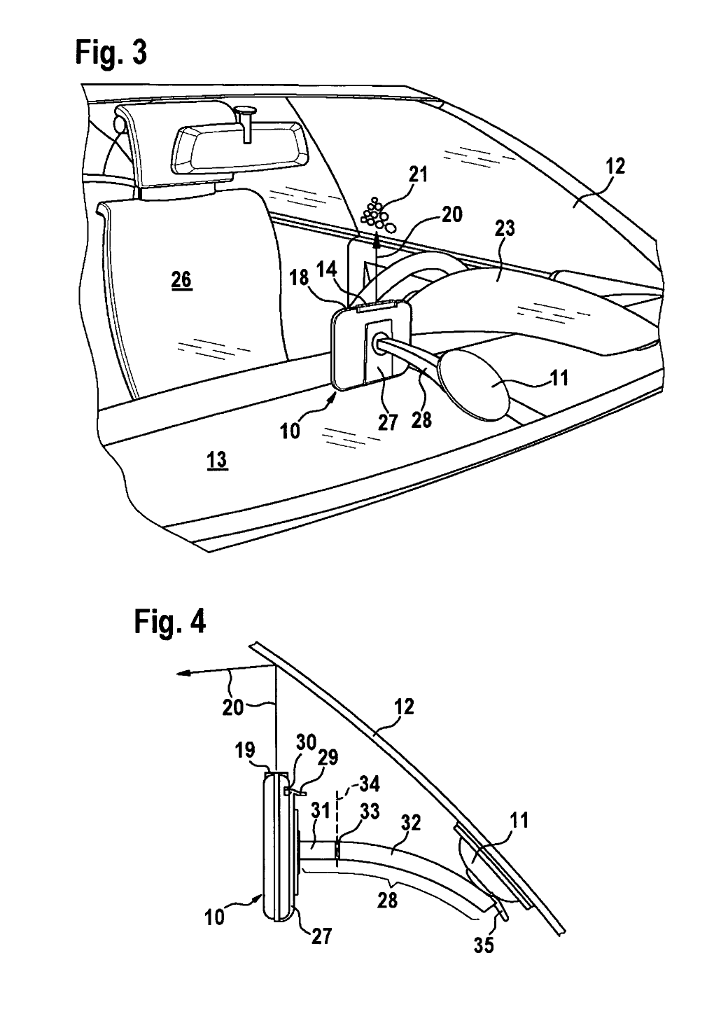

In FIG. 3, calculation device 10 is shown in a view from outside the vehicle, looking toward driver's seat 26. Calculation device 10 is inserted into a holding arm 27 that is connected to suction cup 11 via a connecting arm 28. Holding arm 27 and/or connecting arm 28 is preferably supported movably with respect to calculation device 10 or with respect to suction cup 11, respectively, so that a position of calculation device 10 can be adapted by a user in such a way that an optimum position of virtual image 21, but also good readability of display surface 14, can be achieved.

FIG. 4 shows, in a detail, the disposition of the calculation device on the holder. Calculation device 10 is inserted into holding arm 27 in such a way that an engagement of holding arm 27 with respect to calculation device 10 can be released via an actuation of a release lever 29. In an embodiment, calculation device 10 has a sensing unit, for example a switch element 30, that records the release of holding arm 27. According to this embodiment, the operation of projection unit 19 is deactivated after the holding arm is released, and thus after calculation device 10 is released out of holder 27. It is correspondingly also possible for operation of projection unit 19 to be automatically activated upon insertion of calculation device 10 onto holding arm 27.

Connecting arm 28 preferably has a first element 31 and a second element 32, which are connected pivotably with respect to one another via an articulation 33, in order to enable adaptation of the position of the calculation device by pivoting about a rotation axis 34 that is drawn with a dashed line in FIG. 4. Suction cup 11 is preferably releasable from, and attachable to, windshield 12 via a lever element 35. In another embodiment it is also correspondingly possible to provide an adhesive connection to windshield 12 instead of a suction cup.

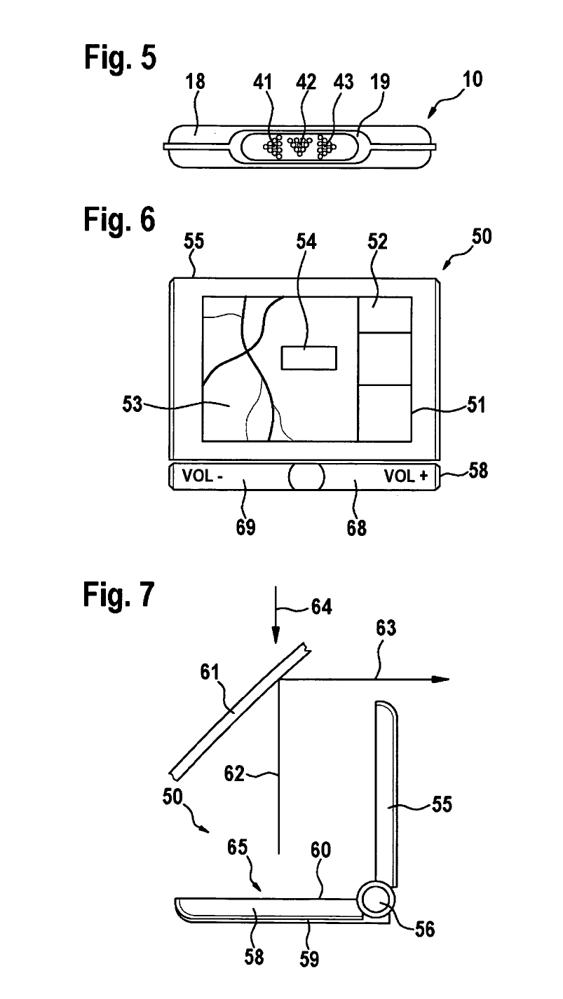

FIG. 5 is a detailed depiction, in a view toward narrow side 18, of calculation device 10 and of projection unit 19 disposed on narrow side 18. In the embodiment shown here, projection unit 19 has a first display 41 of an arrow to the left, a second display 42 of an arrow to the front, and a third display 43 of an arrow to the right. The individual displays 41, 43, 43 are preferably constituted by a plurality of light-emitting diodes that can respectively be triggered collectively in order to cause the various symbols to be displayed. In another embodiment it is also possible to provide a matrix display that is constituted from multiple light-emitting diodes, so that by controlled triggering of individual ones of these light-emitting diodes, corresponding symbols can be formed and can be projected into the windshield. It is also possible, however, to use other display technologies instead of light-emitting diodes, for example electroluminescent displays.

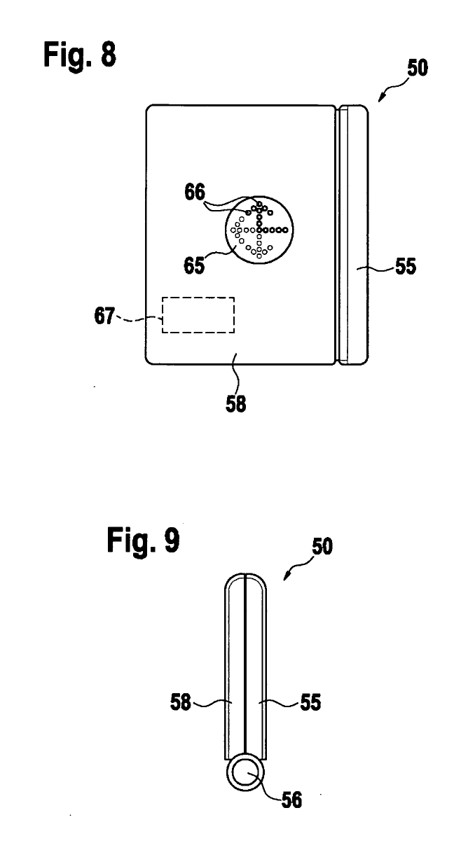

FIGS. 6 to 9 depict a different exemplifying embodiment of a calculation device according to the present invention. A calculation device 50 according to the present invention has on its front side a display surface 51 in which, for example, an operating menu 52, a map depiction 53, and/or a text window 54 can be depicted. Display surface 51 is disposed in a first housing part 55 that is connected via an articulation element 56 to a second housing part 58 that is not visible in FIG. 6. A first operating element 69, and a second operating element 68 for volume control, are mounted on articulated connection 56. FIG. 7 depicts calculation device 50 in a side view. Second housing part 58, which is preferably supported in a holder 59 in the vehicle, for example on an instrument panel, is disposed at an angle of approximately 90° to first housing part 55. A projection unit 65 is disposed on an upper side 60 of second housing part 58. Second housing part 58 is supported in this context, with respect to a windshield 61, in such a way that a light beam 62 from projection unit 65 strikes windshield 61 and is reflected therefrom, so that light is radiated in arrow direction 63. Looking in a direction opposite to arrow direction 63, a virtual image is visible to an observer as a result of reflection from windshield 61. FIG. 8 depicts a plan view in arrow direction 64 of FIG. 7. Projection unit 65 is now visible in a view looking toward second housing part 58. In the embodiment shown here, projection unit 65 has a plurality of light-emitting diodes 66, which are disposed in such a way that they can depict various symbols when connected appropriately. In the embodiment shown here, a variety of arrow symbols can be depicted, depiction of an arrow to the right being shown in the particular embodiment shown here. When calculation device 50 is removed from holder 59, it can (as depicted in FIG. 9) be folded up by rotating second housing part 58 relative to first housing part 57 about articulated connection 56, so that the first and the second housing part 55, 58 rest against one another. In an embodiment, a GPS receiving unit 67, which is depicted with dashed lines in FIG. 8, is disposed in second housing part 58.

1-8. (canceled)

9. A device for use in a vehicle, comprising:
a housing;
a planar display, situated in the housing, for direct readout of information in the planar display; and
a projection unit, situated in the housing, for generating a virtual image by projection.

10. The device according to claim 9, wherein the projection unit generates a virtual image by projection onto a windshield of the vehicle.

11. The device according to claim 9, wherein the projection unit includes a plurality of light-emitting diodes that can at least in part be triggered separately.

12. The device according to claim 9, wherein the housing has a narrow side, and the projection unit is situated on the narrow side of the housing.

13. The device according to claim 9, wherein the housing can be folded out, and the projection unit is situated on an inner side of the housing.

14. The device according to claim 9, wherein a plurality of different symbols can be projected with the projection unit, a separate light source assemblage being provided for each symbol.

15. The device according to claim 9, further comprising a sensing unit for ascertaining whether the device is inserted into a holder, and for automatically deactivating the projection unit after a removal of the device from the holder.

16. The device according to claim 9, further comprising a route determination unit for determining a route of travel to a destination and for outputting driving advisories via at least one of the planar display and the projection unit.

17. The device according to claim 9, wherein the device is used to generate a virtual image in a windshield of a motor vehicle.
